(19) United States
(12) Patent Application Publication
(10) Pub. No.: US 2025/0172763 A1
(43) Pub. Date: May 29, 2025

(54) DUST CAPS AND RELATED METHODS

(71) Applicant: Sumitomo Electric Lightwave Corp., Raleigh, NC (US)

(72) Inventors: Guilherme Doro Roncoleta, Irvine, CA (US); Daizo Nishioka, Irvine, CA (US)

(21) Appl. No.: 18/905,396

(22) Filed: Oct. 3, 2024

Related U.S. Application Data
(60) Provisional application No. 63/602,898, filed on Nov. 27, 2023.

(51) Int. Cl. G02B 6/38

(52) U.S. Cl. CPC G02B 6/3849

(57) ABSTRACT

A dust cap includes a main body for insertion within a port of a connector adapter, the main body including a spring portion to adjust a length of the main body of the connector adapter based on whether the dust cap is in a compressed state or an uncompressed state, and a ferrule cavity at an insertion end of the main body to cover a ferrule end of a connector therein to block dust from contaminating the ferrule end while the ferrule cavity covers the ferrule end. A grip is attached to a proximal end of the main body to assist in inserting the dust cap into the port of the connector adapter or in removing the dust cap from the connector adapter. The proximal end is an opposite end of the main body from the insertion end.

### CROSS-REFERENCE TO RELATED APPLICATION

This application claims priority to U.S. Provisional Patent Application Ser. No. 63/602,898, filed on Nov. 27, 2023, the disclosure of which is incorporated by reference herein in its entirety.

### BACKGROUND

The rapid growth of e-commerce, video streaming services, and cloud computing services requires a commensurate rapid growth in computing infrastructure, including locations commonly referred to as “datacenters.” In order for a datacenter to be operational, however, not only must each of the computer servers be installed within racks in the datacenter and provided with power, but these computer servers must be interconnected together and/or with communications equipment (e.g., switches) that is also provided within such datacenters, such that data can be transferred to/from/between each of these computer servers for performing a designated function.

Due to the proliferation of high-speed internet connections for users, the need for increased data transmission bandwidth continues to increase. One of the most efficient data transfer cable mediums is fiber optic cable, through which a signal can travel at speeds approaching the speed of light. However, such fiber optic cables must first be “terminated,” meaning to have a connector rigidly attached to the end of the fiber optic cable. These connectors allow for a rigid connection between the fiber optic cable and the computer infrastructure device (e.g., computer or switch) that ensures uninterrupted receipt/transmission of data through the fiber optic cable, while also protecting the fiber optic cable from being damaged.

When building a datacenter, data transmission cables, such as fiber optic cables, must be connected between computer servers and/or switches. However, the act of “terminating” a fiber optic cable is very time and labor intensive. Thus, the use of pre-terminated cables can be used to significantly reduce the amount of time required to bring new datacenters online, since the cable termination step can be omitted. It is often necessary for fiber optic cables to be connected to an adapter mounted within a panel. However, the handling of such pre-terminated cables by datacenter installation personnel and the connection of such pre-terminated cables to an adapter is cumbersome at present. Thus, a need exists for a device suitable for use with such adapters that simplifies the installation of such pre-terminated cables in the adapters and, more particularly, for dust caps that protect fiber optic cables from contamination with dust, which can reduce signal transmission performance.

### SUMMARY

In an embodiment, a dust cap is disclosed comprising a main body configured for insertion within a port of a connector adapter. The main body comprises a spring portion configured to adjust a length of the main body of the connector adapter based on whether the dust cap is in a compressed state or an uncompressed state, and a ferrule cavity at an insertion end of the main body, the ferrule cavity being configured to cover a ferrule end of a connector therein to block dust from contaminating the ferrule end while the ferrule cavity covers the ferrule end. A grip is attached to a proximal end of the main body, the grip being configured to aid a user in inserting the dust cap into the port of the connector adapter or in removing the dust cap from the connector adapter. The proximal end is an opposite end of the main body from the insertion end. A method for connecting a dust cap to a connector adapter using the dust cap is also disclosed.

### BRIEF DESCRIPTION OF THE DRAWINGS

One or more example embodiments of the disclosed device are described herein, with reference to the accompanying drawings, in which:

FIGS. 1A and 1B are respective schematic illustrations showing the internal construction of an example fiber optic cable;

FIG. 2 is a perspective view of an example embodiment of a fiber optic 1-port connector adapter;

FIG. 3 is a side view of the connector adapter shown in FIG. 2;

FIG. 4 is a front view of the connector adapter shown in FIGS. 2 and 3;

FIG. 5 is a perspective view of an example embodiment of a connector adapter installation housing for having a plurality of connector adapters shown in FIGS. 2-4 installed therein;

FIG. 6 is a front view of the connector adapter installation housing shown in FIG. 5;

FIG. 7 is a perspective view of an example connector for use in terminating an end of a fiber optic cable, the connector shown being configured for removable insertion within the example connector adapter shown in FIGS. 2-4;

FIG. 8 is a front view of the connector shown in FIG. 7;

FIG. 9 is a front isometric view of a first example embodiment of a dust cap for covering installation within the example connector adapter shown in FIGS. 2-4 to cover the ferrule end of the example connector shown in FIGS. 7 and 8, so as to prevent dust infiltration and contamination;

FIG. 10 is a rear isometric view of the first example embodiment of the dust cap shown in FIG. 9;

FIG. 11 is a side plan view of the first example embodiment of the dust cap shown in FIGS. 9 and 10;

FIG. 12 is a front plan view of the first example embodiment of the dust cap shown in FIGS. 9-11;

FIG. 13 is a rear plan view of the first example embodiment of the dust cap shown in FIGS. 9-12;

FIG. 14 is a front isometric view of a second example embodiment of a dust cap for covering installation within the example connector adapter shown in FIGS. 2-4 to cover the ferrule end of the example connector shown in FIGS. 7 and 8, so as to prevent dust infiltration and contamination;

FIG. 15 is a rear isometric view of the second example embodiment of the dust cap shown in FIG. 14;

FIG. 16 is a side plan view of the second example embodiment of the dust cap shown in FIGS. 14 and 15;

FIG. 17 is a front plan view of the second example embodiment of the dust cap shown in FIGS. 14-16;

FIG. 18 is a rear plan view of the second example embodiment of the dust cap shown in FIGS. 14-17;

FIG. 19 is an isometric view of an assembly comprising the example connector adapter of FIGS. 2-4, the first example embodiment of the dust cap shown in FIGS. 9-13 installed in a port on a first side of the connector adapter, and the example connector of FIGS. 7 and 8 installed in a port on a second side of the connector adapter, opposite the side in which the dust cap is installed;

FIG. 20 is a side plan view of the assembly shown in FIG. 19, with the connector adapter being shown in wire frame to show the manner of engagement of the dust cap with the connector internal to the connector adapter;

FIG. 21 is a cross-sectional side view of the assembly shown in FIGS. 19 and 20, with the connector adapter omitted for clarity, showing the engagement of the dust cap over and covering the ferrule end of the connector;

FIG. 22 is a side plan view of another assembly comprising the example connector adapter of FIGS. 2-4, along with two (2) of the dust caps shown in FIGS. 9-13 that are installed in respective ports on the opposite sides of the connector adapter; and

FIG. 23 is a partially exploded assembly view of another assembly comprising the connector adapter installation housing of FIGS. 7 and 8, a plurality of 2-port connector adapters installed within the connector adapter installation housing, ramp adapters that are aligned with a row of the connector adapters for removable installation thereon, and the example dust caps shown in FIGS. 9-13, each of which is aligned with a different one of the ports of the connector adapters for removable installation therein.

The drawings are not necessarily to scale. The drawings are merely representations, not intended to portray specific parameters of the disclosure. The drawings are intended to depict example embodiments of the disclosure, and therefore are not to be considered as limiting in scope. In the drawings, like numbering represents like elements.

### DETAILED DESCRIPTION

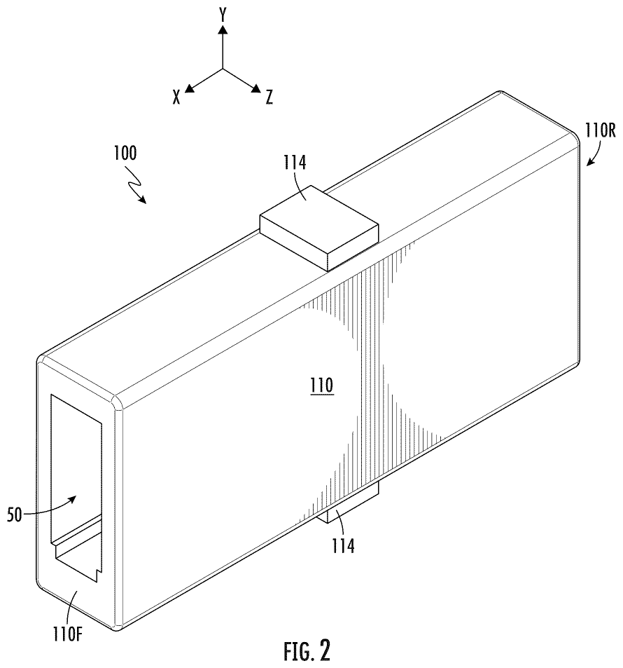

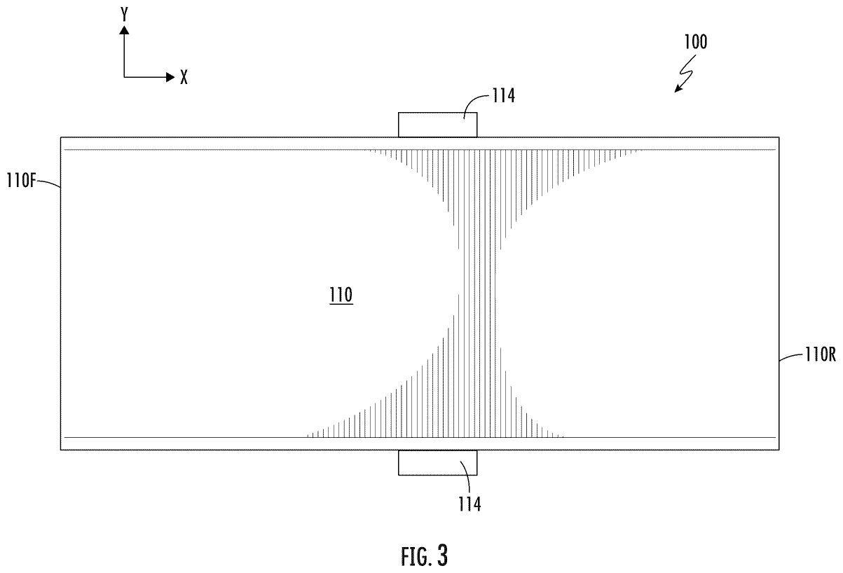

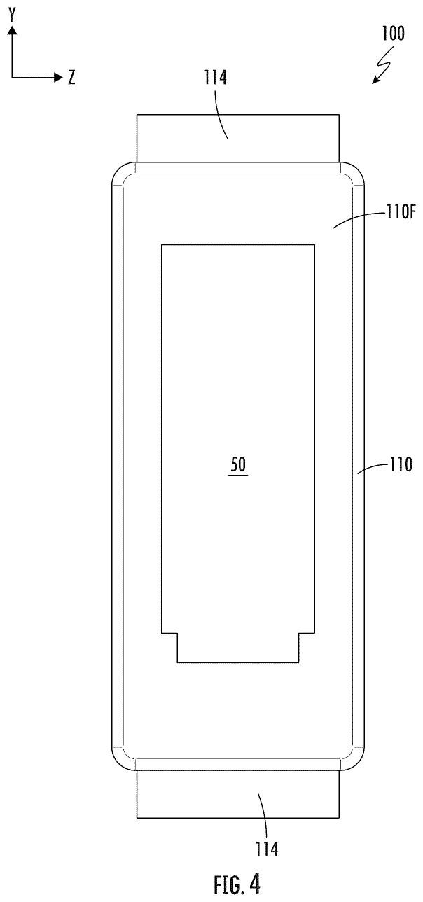

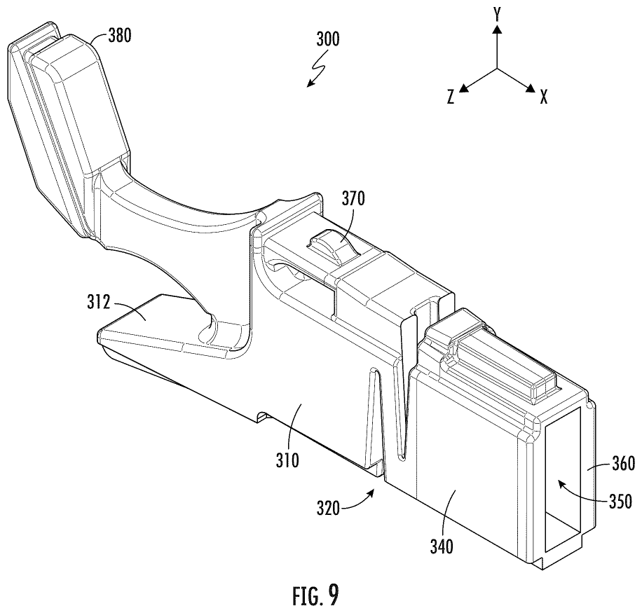

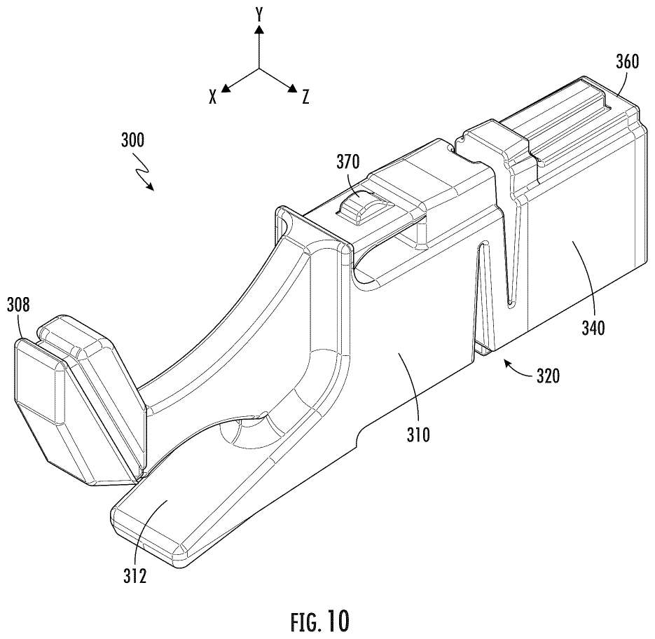

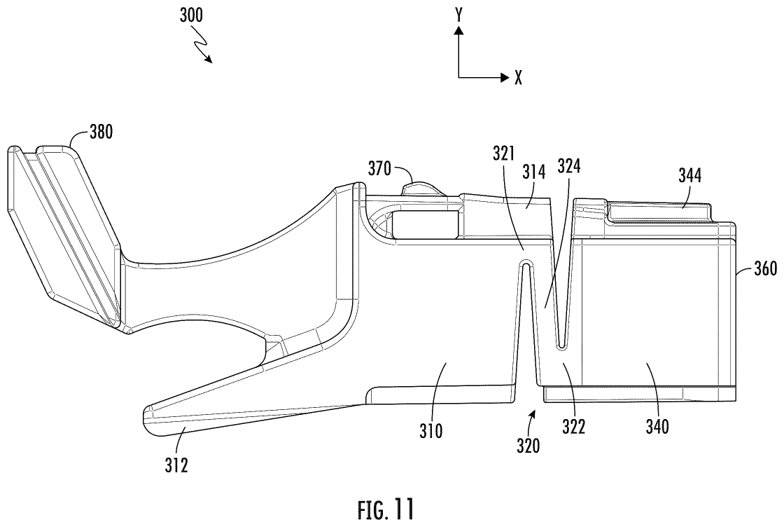

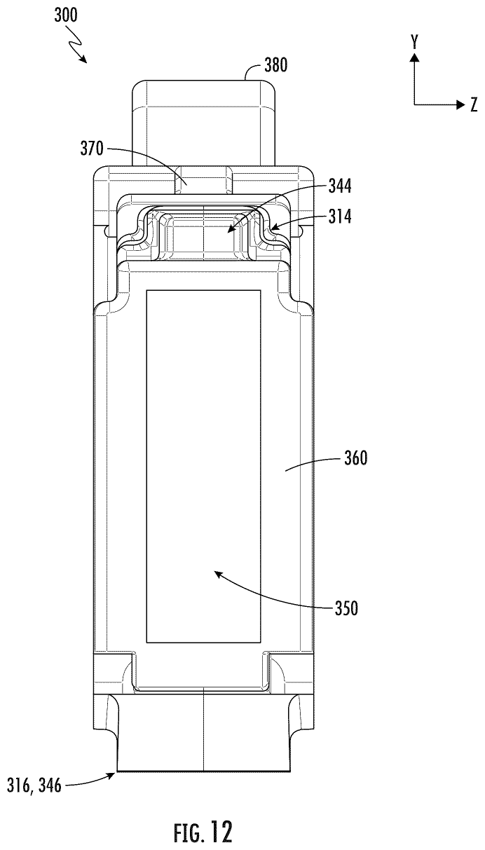

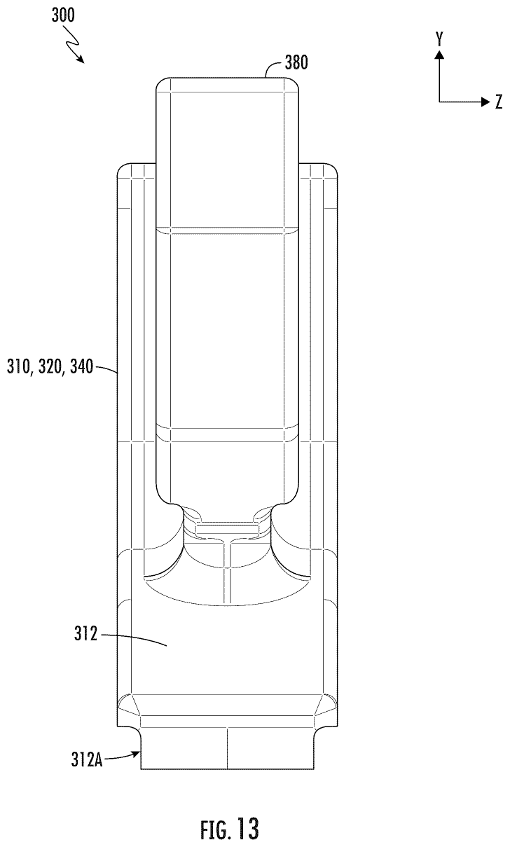

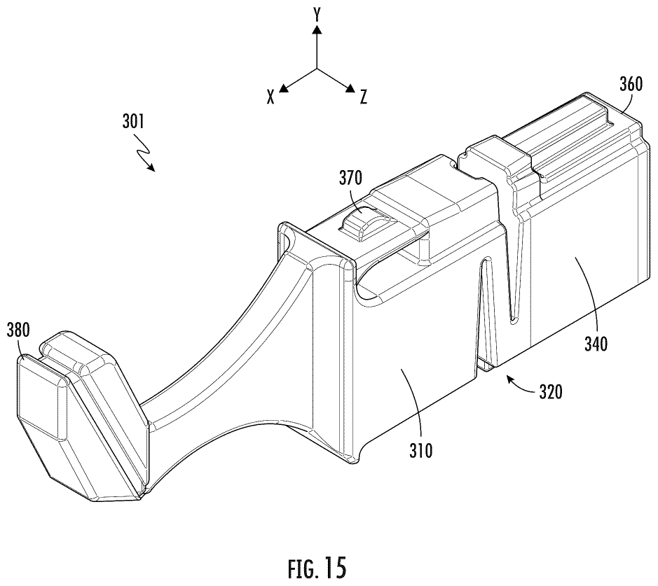

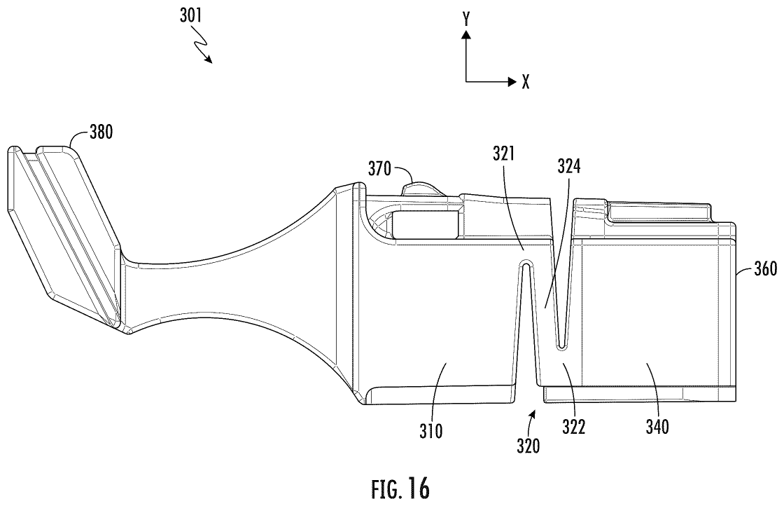

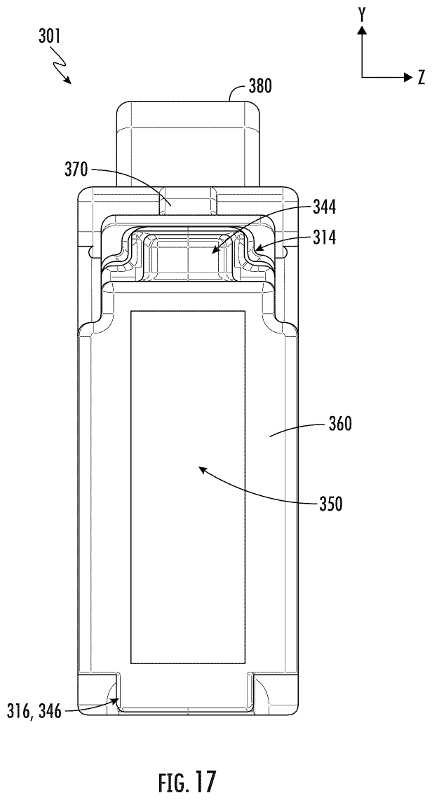

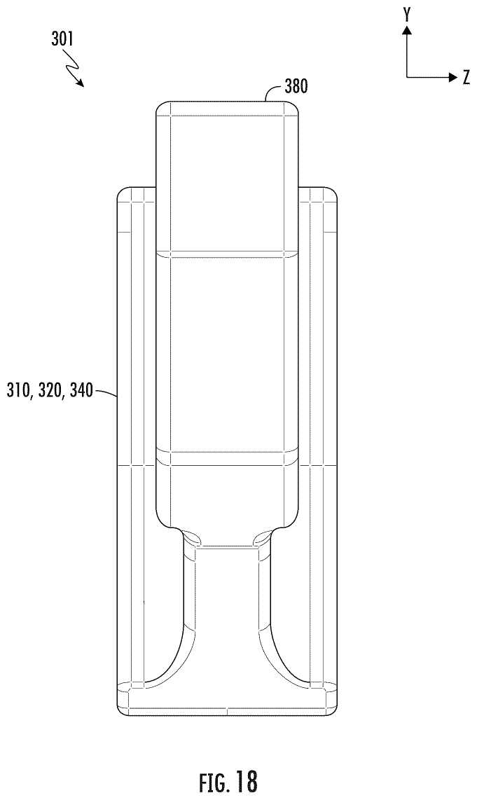

In accordance with the present disclosure, example embodiments of dust caps (300, 301, see FIGS. 9-23) for use in preventing dust infiltration and contamination of fiber optic connector ferrule ends installed within a connector adapter 100, an example embodiment of which is shown in FIGS. 2-4, will now be described more fully hereinafter with reference to the accompanying drawings, in which preferred embodiments of the present disclosure are presented. The dust caps of the present disclosure may, however, be embodied in many different forms and should not be construed as being limited to the embodiments set forth herein. Rather, these example embodiments are provided so that this disclosure will convey certain example aspects of such dust caps to those skilled in the art. In the drawings, like terminology is used herein to refer to like elements in different example embodiments throughout, unless expressly noted to the contrary herein.

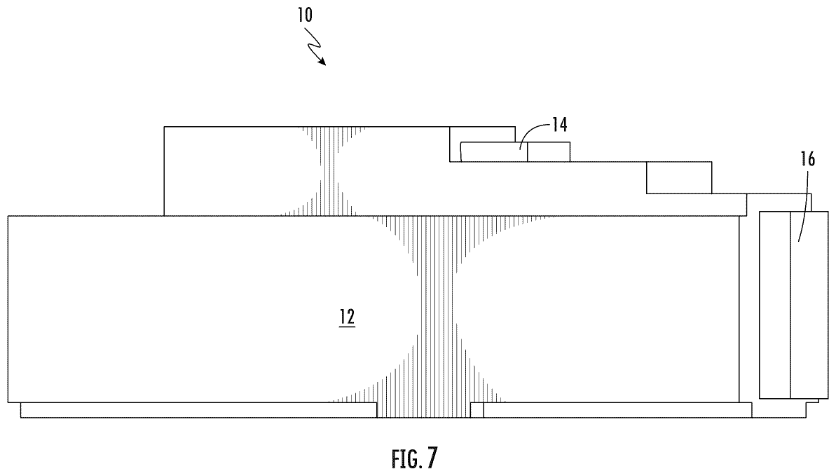

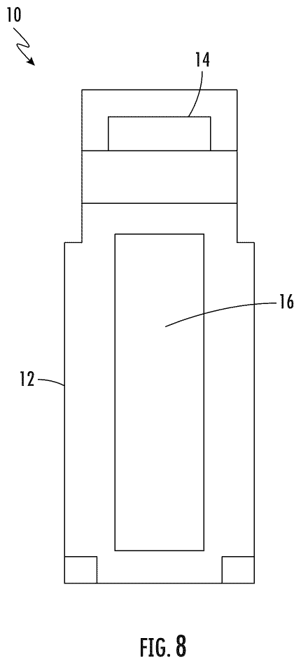

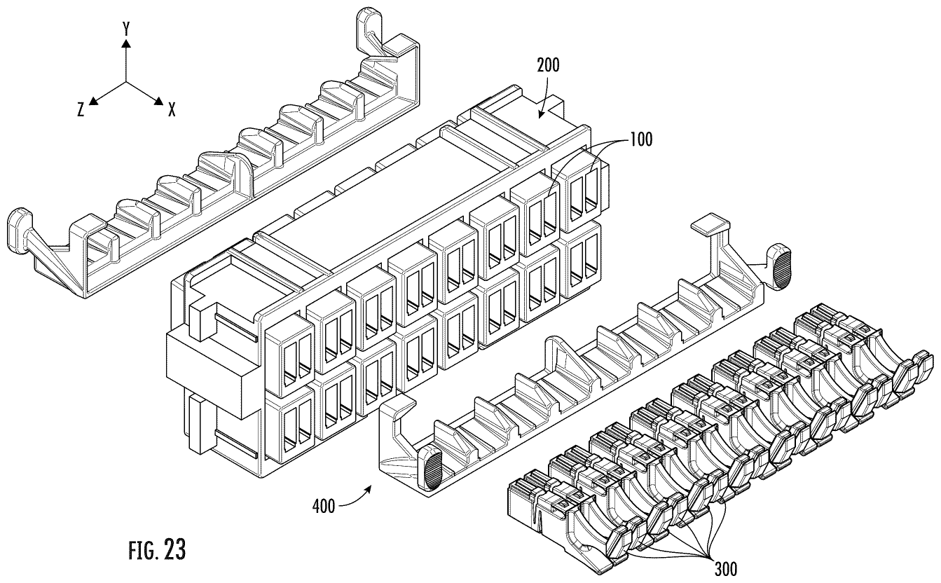

The example embodiments of the dust caps 300, 301 are configured for use with (e.g., to engage with) fiber optic cable connectors (10, see FIGS. 7 and 8). Fiber optic cables can be either pre-terminated or terminated with these connectors 10 in situ before such connectors are plugged into one of the ports of the connector adapter 100. In some embodiments, the dust caps 300, 301 may be designed to be operable with connector adapters 100 that are designed for use with cable types other than fiber optic cables. In some embodiments, the features of the dust caps 300, 301 disclosed herein can be duplicated to allow for a single dust cap 300, 301 to be connected to or inserted within a plurality of ports 50 of a multi-port connector adapter 100 (see, e.g., FIG. 23) to cover and protect from dust contamination of the ferrule end (16, see FIGS. 7 and 8) of more than one fiber optic cable connector 10.

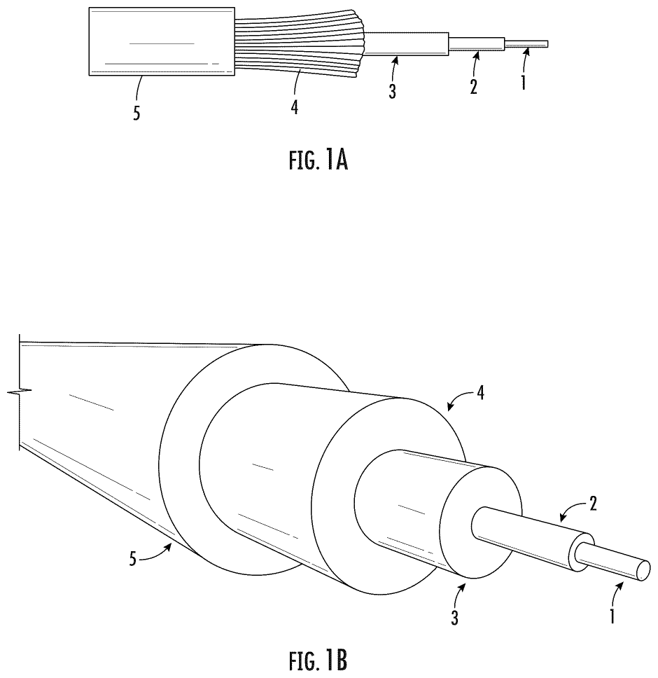

The connector adapter 100 shown in FIGS. 2-4 is designed and configured to provide a secure and robust connection between the ferrule end 16 of a connector 10 (see FIGS. 7 and 8) of a first fiber optic cable (see FIGS. 1A, 1B), which is installed into a port 50 of the connector adapter 100, and the ferrule end 16 of a connector 10 of a second fiber optic cable, which is installed into another port 50 on an opposite side of the connector adapter 100, the port 50 in which the connector 10 of the second fiber optic cable is installed being coaxially-aligned with the port 50 in which the connector 10 of the first fiber optic cable is installed, so that signals (e.g., data) can be readily transmitted between the first fiber optic cable and the second fiber optic cable. While the example connector adapter 100 shown in FIGS. 2-4 has only a single port 50 on the front and rear sides 110F, 110R thereof, the dust caps 300, 301 disclosed herein can be installed within a cable adapter 100 having any quantity of ports 50, so long as the dust cap 300, 301 is geometrically compatible for connecting to or insertion within the ports 50. Regardless of the quantity of ports 50 on each side of the connector adapter 100, each port 50 on one side of the connector adapter 100 is arranged substantially coaxial to a corresponding one of the ports 50 on the other, opposite side of the connector adapter 100.

Referring to FIGS. 1A and 1B, respective side and perspective views of an example embodiment of a conventional fiber optic cable are shown. There is a core 1 at the center of the cable. In some instances, the core 1 may comprise multiple fiber optic filaments. The core 1 is surrounded by a cladding 2, which can also be referred to as a “cladding layer.” The filament(s) in the core 1 can also be referred to as ferrules. In some instances, each filament in the core 1 of a multi-filament fiber optic cable may have its own cladding 2. The cladding layer(s) 2 is/are surrounded by a coating 3, which can also be referred to as a “coating layer.” Strengthening fibers 4 are provided around the coating 3 and are surrounded by an outer cable jacket 5. When terminated, the filament(s) of the core 1 are inserted and secured within a connector 10 (see FIGS. 7 and 8) such that, when the connector 10 is inserted within a port 50 of a connector adapter 100, the connector is held in a prescribed position and, commensurately, the filament(s) are also held in a prescribed position by engagement of the connector 10 with the port 50 of the connector adapter 100. It is these connectors 10, attached to the fiber optic cable generally of the type shown in FIGS. 1A and 1B, that are installed into the fiber optic connector adapters 100 shown in FIGS. 2-4, with or without the aid of a ramp adapter (see FIG. 23).

The core 1 of each fiber optic cable is secured to the connector 10 to define, at least in part, the ferrule end 16 of the connector 10. The connectors 10 of fiber optic cables that are to be connected together by the connector adapter 100 are each installed into one of the coaxially-aligned pairs of ports 50 of the connector adapter 10, so that the ferrule end 16 (e.g., including the core 1 thereof) of one connector 10 is substantially coaxially aligned with the ferrule end 16 (e.g., including the core 1 thereof) of the other connector 10. Thus, by plugging a connector 10 of a first cable into a first port 50 and by plugging a connector 10 of a second cable into a second port 50, which is on an opposite side of the connector adapter 100 and coaxially aligned with the first port 50, the ferrule end 16 secured in the first port 50 by the connector 10 of the first cable is coaxially aligned with the ferrule end 16 secured in the second port 50 by the connector 10 of the second cable, such that a signal may be transmitted between the first cable and the second cable, specifically, between the core 1 of the fiber in the first cable and the core 1 of the fiber in the second cable, thereby minimizing signal loss through the connector adapter 100.

The example connector adapter 100 shown in FIGS. 2-4 is designed and configured to maximize the flexibility of movements of the cables during maintenance and/or installation actions performed with respect to the cables within the datacenter. Such connector adapters 100 do not interfere with the cable or connector efficiency and/or workability. Such connector adapters 100 have a construction that is configured such that a ramp adapter can be removably attached to either of the longitudinal ends of the connector adapter 100 (see, e.g., FIG. 23), the ramp adapter being configured to advantageously reduce the costs associated with maintenance and/or installation actions and also reduce the risk of damage to the fiber optic cables due to improper handling or movements (e.g., excessive bending, improper application of insertion force to the cable etc.) of the fiber optic cable, which is known to cause reduced signal transmission performance.

The example dust caps 300, 301 for optical connectors 10 disclosed herein are each designed and configured to provide a secure way to protect the optical connector 10 against contamination with dust. The dust caps 300, 301 have a spring portion 320 that allows the dust cap 300, 301 to compliantly protect the ferrule end 16 of a connector 10 installed in an opposing, coaxially-aligned port 50, while also allowing for installation of a dust cap 300, 301 in both of the coaxially-aligned ports 50 of the connector adapter 100. The presently disclosed dust caps 300, 301 protect both the connectors 10 and the connector adapters 100 against infiltration and contamination with dust or other sufficiently small debris, thereby ensuring that the core 1 of each fiber optic cable at the ferrule end 16 of the connector 10 thereof is shielded from dust infiltration and contamination.

The example dust caps 300, 301 for optical connectors 10 disclosed herein are each designed and configured to maximize the protection of the ferrule end 16 of such connectors 10 used for terminating the ends of a fiber optic cable against dust that is present within a data center or other environment in which such connector adapters 100 may be used. The example dust caps 300, 301 disclosed herein do not interfere with cable or connector efficiency and workability. The construction of such example dust caps 300, 301 reduces the costs associated with maintenance and installation actions, and also minimizes the risk of damage to the fiber optic cables due to dust in the environment in which the connector adapters 100 and connectors 10 are used. Thus, by using such example dust caps 300, 301 as are presently disclosed herein, the frequency with which cleaning processes must be performed for removing dust from the ferrule ends 16 of the connectors 10 is reduced. Failure to perform such cleaning processes can otherwise result in reduced signal transmission performance between connectors of fiber optic cables.

To achieve these benefits, each of the example dust caps 300, 301 disclosed herein comprises a ferrule cavity, generally designated 350. This ferrule cavity 350 is formed at, and extends internally within the dust cap 300, 301 from, a distal, or insertion end 360 of such dust cap 300, 301. The spring portion 320 of the example dust caps 300, 301 allows two such dust caps 300, 301 to be installed coaxial with each other to protect the connector adapter 100 itself against infiltration and contamination with dust, thereby preventing damage to the core 1 or ferrule end 16 during cable maintenance and installation actions from dust that would, except for the presence of two such example dust caps 300, 301, already be present within the ports 50 of the connector adapter 100 prior to connection to or insertion of the connector 10 into one of such ports 50.

Through the use of the example dust caps 300, 301 disclosed herein, protection of the ferrule end 16 of the connector 10 and, thus, of the cable itself, against contamination with dust during cable installation and maintenance actions is enhanced, and the time associated with cable maintenance and/or installation actions for cleaning the connector to remove dust from the ferrule end 16 thereof and/or from the port(s) 50 of the connector adapter 100 is reduced, commensurately reducing the labor costs associated with performing such maintenance and/or installation actions more frequently, as would be necessary if the dust caps 300, 301 disclosed herein were not used. The example dust caps 300, 301 disclosed herein prevent dust infiltration and contamination on and/or within the connector 10 and/or the connector adapter 100 during the cable insertion process by acting as a protection to the ferrule end 16 of the connector 10, avoiding damage due to dust during the cable insertion process.

FIGS. 2-4 show an example embodiment of a conventional single-port fiber optic connector adapter 100. The connector adapter 100 comprises a housing 110, in which one port 10 is provided on opposing front and rear sides 110F, 110R thereof. Thus, there is one port 50 formed on the front side 110F and one port 50 formed on the rear side 110R of the housing 110, including a first port 50 formed on the front side 110F of the housing 110 and a second port 50 formed on the rear side 110R of the housing 110. The first port 50 extends towards the second port 50, such that a cavity or passage (e.g., a volumetric region) is formed extending between the first and second ports 50. The single-port fiber optic connector adapter 100 shown in FIGS. 2-4 is only an illustrative example and the dust caps 300, 301 disclosed herein can be used (e.g., installed) in a port of a multi-port fiber optic connector adapter in the same manner as is described herein in relation to the single-port connector adapter 100 shown in FIGS. 2-4. Thus, regardless of the quantity of ports 50 on each of the front and rear sides 110F, 110R of the housing 110 of the connector adapter 100, there are as many cavities defined through the housing 110 of the connector adapter 100 as there are pairs of ports 50 on the opposing front and rear sides 110F, 110R of the housing 110 thereof. In some example embodiments of multi-port connector adapters, the cavities can be fully separated or isolated from each other in the z-direction by internal walls, which extend the full height of the cavity formed by such internal wall within the housing 110. In other example embodiments of multi-port connector adapters, the walls separating laterally adjacent (e.g., in the z-direction) ports 50 may extend over only a portion of the height of the housing 110, in which case the cavities formed by laterally adjacent pairs of ports 50 would not be separated or isolated from each other in the z-direction.

The housing 110 has a fastener 114 configured to secure the housing 110 to a panel, such as a network patch panel. Any suitable fastener type may be used. The fastener 114 is preferably of a type by which the housing 110 may be inserted and removed from the panel in a tool-less manner (e.g., manually).

The dust caps 300, 301 disclosed herein can be formed of, comprise, or consist of any suitable material, including plastic, ceramic, metal, and/or any combinations thereof.

The fiber optic connector adapter 100 shown in FIGS. 2-4 is merely an example of the type of connector adapter 100 with which the dust caps 300, 301 disclosed herein can be used and the quantity of ports 50 for a connector adapter 100 with which such dust caps 300, 301 may be used is not limited to having any specific quantity of ports 50.

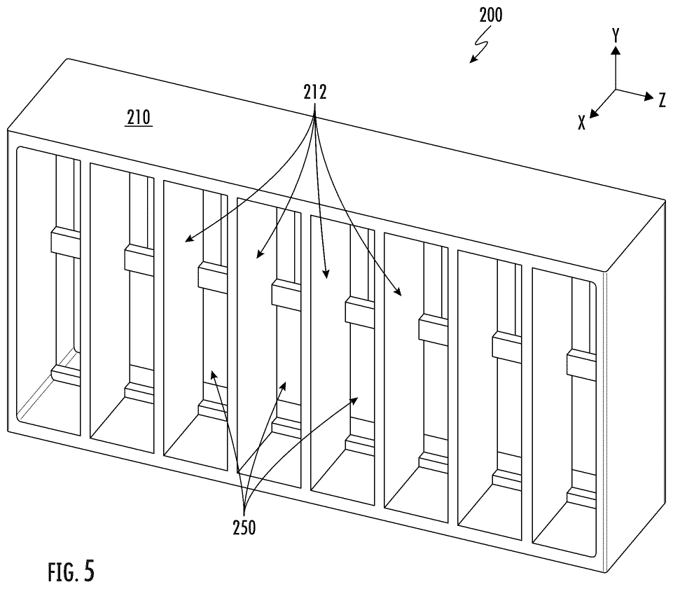

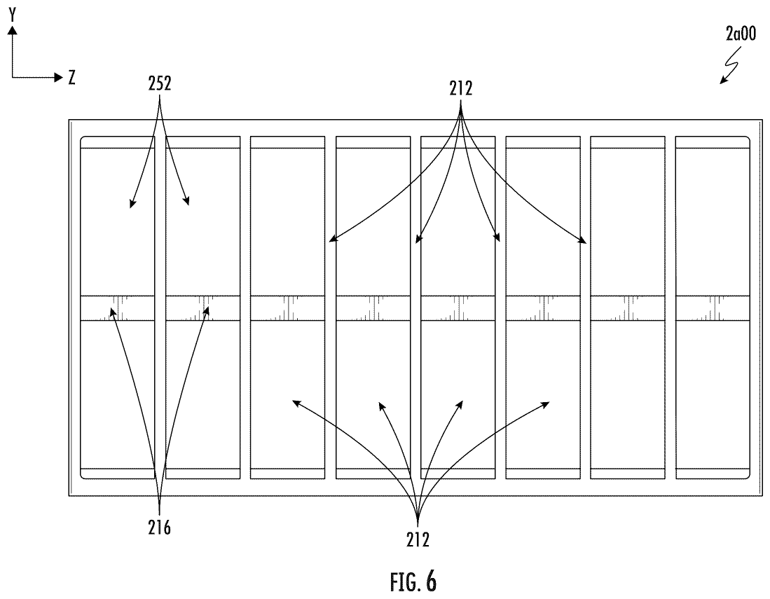

The ports 50 disclosed herein are of a type suitable for coupling together terminated connectors 10 of fiber optic cables. An example of a suitable fiber optic cable connector includes a very small form factor (VSFF) multi-fiber optical connector 10. These connector adapters 100 are configured for connecting to or insertion or attachment to a panel, preferably, a network patch panel, such as the connector adapter installation housing 200, shown in FIGS. 5 and 6. Thus, a network patch panel comprising a panel and a plurality of the presently disclosed connector adapters 100 is also disclosed herein. Similarly, a network installation comprising such a network patch panel and a plurality of cables with connectors inserted into the ports 50 of the presently disclosed connector adapters 100 is also disclosed herein.

FIGS. 5 and 6 show an example embodiment of a connector adapter installation housing, generally designated 200, into which a plurality of the connector adapters 100 shown in FIGS. 2-4 can be removably installed. The connector adapter installation housing 200 has an outer housing 210. The housing 210 has generally vertically-extending divider walls that define cavities 250 within the housing 210. In some embodiments, each cavity 250 is shaped to accept one of the connector adapters 100 shown in FIGS. 2-4 therein. In the example shown in FIGS. 5 and 6, each of the cavities 250 has an upper portion 252 and a lower portion 254, the upper portion 252 being configured to have a connector adapter 100 installed therein and to retain such connector adapter 100 vertically above another connector adapter 100 installed within the lower portion 254 of the cavity 250. To define the upper and lower cavities 252, 254, the housing 210 has a horizontal wall 216 formed in each of the cavities 250, internal to such cavities 250, substantially at a vertical midpoint of the cavity 250, such that the upper cavities 252 are substantially the same volume as the lower cavities 254. The upper and lower cavities 252, 254 are separated, at least partially, by the respective horizontal walls 216.

FIGS. 7 and 8 show an example fiber optic connector, generally designated 10, for terminating one end of a fiber optic cable. The connector 10 has a body 12 that is shaped to be compatible with (e.g., being shaped to have a substantially identical profile to the port into which such connector is to be inserted) insertable within one of the ports of the connector adapter 100 shown in FIGS. 2-4. The fiber optic cable is inserted through the proximal end of the connector 10 and is terminated at the ferrule end 16 of the connector 10, the ferrule end 16 being opposite the proximal end. The fiber optic cable is secured such that the core 1 thereof is secured at and/or within the ferrule end 16. The body 12 of the connector has a length that is substantially half the length (e.g., in the x-direction) of the cavity, formed by and between the pair of ports 50, into which the connector 10 is to be inserted, such that two of such connectors 10 can be engaged within (e.g., at a midpoint of) the cavity formed by and between the pair of ports 50, thereby allowing data and/or signal transmission between the core(s) 1 of the fiber optic cables at the ferrule end 16 of the respective connector 10. The connector 10 has a latch 14 that is configured to engage with a latch slot formed in the housing 110 of the connector adapter 100, the latch 114 being configured to resist removal of the connector 10 from the port 50 into which such connector 10 is inserted unless/until the latch 14 is disengaged from (e.g., by undergoing a vertical movement out of) the latch slot formed in the housing 110. Similarly, the latch 14 automatically engages within the latch slot of the housing 110 of the corresponding port 50 into which the connector 10 is inserted during the cable insertion process. The shape of the ferrule end 16 shown is merely illustrative and the design of the connectors 10 and/or of the dust caps 300, 301 disclosed herein is in no way limited to the shapes, designs, etc. shown and described herein; thus, the ferrule end 16 may have any shape (e.g., profile and/or depth) without limitation.

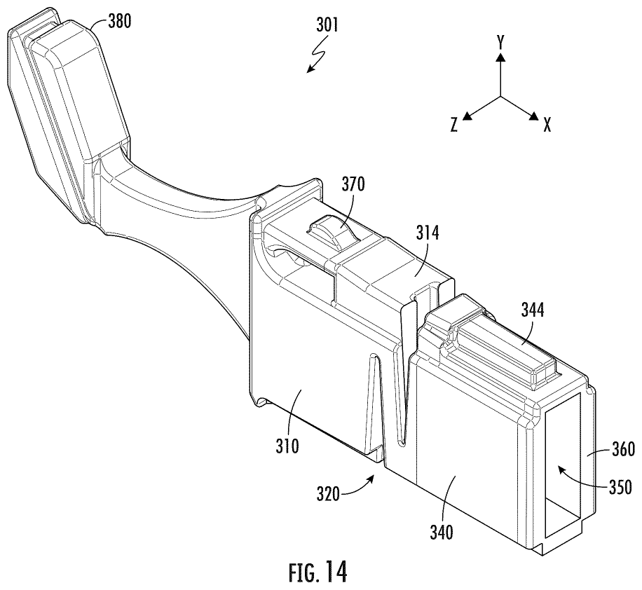

FIGS. 9-13 show various aspects of a first example embodiment of a dust cap, generally designated 300, for removable installation within any of the ports 50 of the example connector adapter 100 shown in FIGS. 2-4. FIGS. 14-18 show various aspects of a second example embodiment of a dust cap, generally designated 301. The dust cap 301 shown in FIGS. 14-18 is substantially identical to the dust cap 300 shown in FIGS. 9-13, with the sole exception being that the second example embodiment of the dust cap 301 shown in FIGS. 14-18 is devoid of (e.g., does not have) the ramp cover 312 of the first example embodiment of the dust cap 300 shown in FIGS. 9-13. Other than for this omitted ramp cover, the features of the second example embodiment of the dust cap 301 shown in FIGS. 14-18 are identical, both in terms of structure and function, to the features of the first example embodiment of the dust cap 300 shown in FIGS. 9-13. Like features between the first and second example embodiments of the dust caps 300, 301 shown herein may not be fully described herein in a manner that is independent of each other.

The dust cap 300, 301 may have a unitary, or monolithic construction (e.g., may be formed as a single, indivisible structure, such as by an injection molding process, an additive manufacturing process, etc.). The dust cap 300 comprises, at a proximal end thereof, a grip 380 and a ramp cover 312. The dust cap 300 has, attached to the grip 380 and the ramp cover 312 and extending away (e.g., in the x-direction) from the proximal end, a base portion 310 and a latch 370. The dust cap 301 comprises, at a proximal end thereof, a grip 380. The dust cap 301 has, attached to the grip 380 and extending away (e.g., in the x-direction) from the proximal end, a base portion 310 and a latch 370.

The latch 370 for both example embodiments of the dust cap 300, 301 is formed in a monolithic manner with the base portion 310. The latch 370 is provided above (e.g., in the y-direction) the base portion 310. At the opposite end of the base portion 310 from where the base portion 310 is attached to the grip 380 and the ramp cover 312, the dust cap 300, 301 comprises a spring portion, generally designated 320. The spring portion 320 is provided between and connects (e.g., directly) the base portion 310 to an extension portion 340 of the dust cap 300, 301. The spring portion 320 extends away from (e.g., in the x-direction) the base portion 310 and the extension portion 340 extends away from (e.g., in the x-direction) the spring portion 320. The extension portion 340 defines, at an opposite end from where the extension portion 340 is attached to the spring portion 320, an insertion end 360. The extension portion 340 has, formed internal thereto and extending away from (e.g., towards the spring portion) the insertion end 360, a ferrule cavity 350.

The latch 370 of the dust cap 300, 301 is configured to resist removal of the dust cap 300, 301 from the port 50 unless/until the latch 370 is disengaged from (e.g., by undergoing a vertical movement out of) the latch slot formed in the housing 110 within the port 50 in which such dust cap 300, 301 is inserted during the cable insertion process.

The grip 380 extends away from the base portion 310 in the X-direction. The grip 380 is shaped to be grasped by a human hand, or at least two or more fingers of a human hand, and pushed towards the connector adapter 100 to insert the dust cap 300, 301 within a port 50 of the connector adapter 100 and also to be pulled away from the connector adapter 100 to remove the dust cap 300, 301 from the port 50 of such a connector adapter 100. The grip 380 may, in some instances, have a circle attached at an end thereof to allow removal of the dust cap 300, 301 from the connector adapter 100 using only one finger (e.g., after having actuated/released the latch 370). The grip 380 is advantageously coaxially aligned with the longitudinal axis of the base portion 310, the spring portion 320, and the extension portion 340.

For the example embodiment of the dust cap 300, which has the ramp cover 312, the ramp cover 312 extends away from the base portion 310 in the X-direction, generally vertically below the grip 380. The ramp cover 312 fits within a ramp portion of a ramp adapter (see, e.g., FIG. 23) or of a connector adapter 100 to prevent the accumulation of dust on/in such ramp portion, thereby preventing a connector 10 that slides along such a ramp portion during an insertion procedure from collecting dust from the ramp portion and introducing such dust into the port 50 of the connector adapter 100 into which the connector 10 is being inserted.

The base portion 310 advantageously has a profile that is substantially identical to the internal profile of the cavity defined by the port 50 into which the dust cap 300, 301 is designed for connection to or insertion within, to prevent dust from passing between the base portion 310 and the inner surface of the walls of such cavity to prevent contamination of the ferrule end 16 of the connector 10 that would otherwise occur even when the dust cap 300, 301 is installed within such cavity.

The spring portion 320 is positioned axially between the base portion 310 and the extension portion 340, so that the spring portion 320 directly connects the base portion 310 and the extension portion 340. The spring portion 320 has a strut 324 that extends at a non-zero angle relative to the X-direction, between a first hinge point 321, where the strut 324 is attached to the base portion 310, and a second hinge portion 322, where the strut 324 is attached to the extension portion 340. The strut 324 shown extends in a substantially linear manner between the first and second hinge points 321, 322. In the example embodiments shown, the dust cap 300, 301 comprises two struts 324 that are separated from each other in the z-direction by a gap. The quantity, thickness, and shape of the struts 324 can be selected based on a spring force desired to be exerted by the dust cap 300, 301. During compression, the strut 324 pivots, relative to the base portion 310, at the first hinge point 321 and, relative to the extension portion 340, at the second hinge point 322.

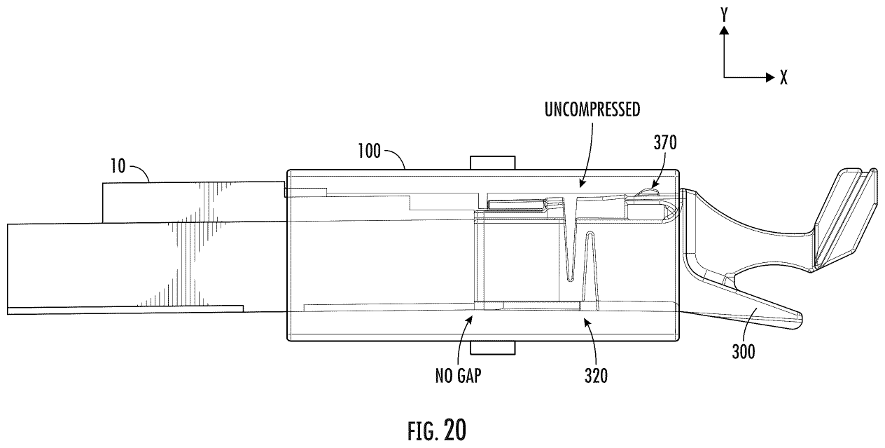

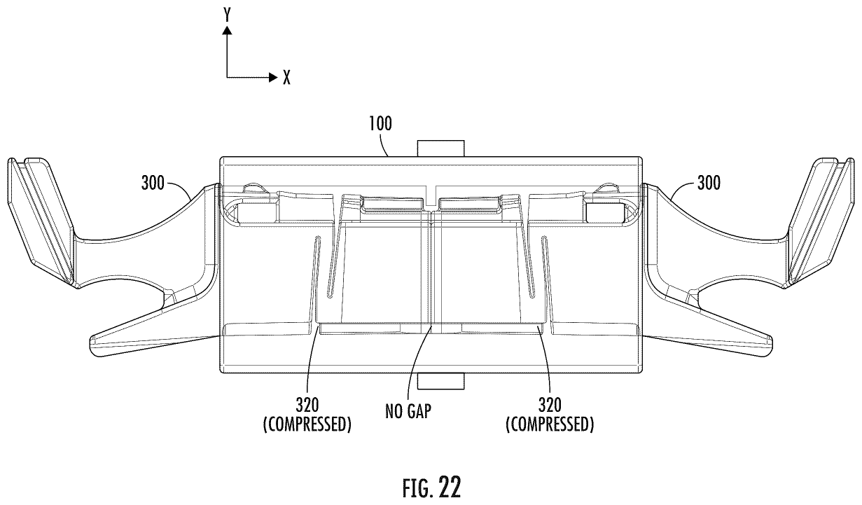

The strut 324 pivots between an uncompressed state (or position) and a compressed state (or position). The length of the dust cap 300, 301 is longer when the strut 324 is in the uncompressed state than when the strut 324 is in the compressed state. This pivoting movement of the strut 324 from the uncompressed state to the compressed state increases the angle of the strut 324 relative to the X-direction. In some embodiments, the strut 324 is arranged at an angle, relative to the X-direction, of 90° or more when in the compressed state. As defined herein, the strut 324 has an angle of less than 90° when the dust cap 300, 301 is in the uncompressed state and greater than 90° when the dust cap 300, 301 is in the compressed state, meaning that, as the strut 324 pivots when the dust cap 300, 301 moves between the compressed and uncompressed states, the strut 324 necessarily moves through an angle of 90°. It is within the scope of the presently disclosed subject matter, however, for the position of the strut 324 relative to the X-direction to be defined as being less than 90° when the dust cap 300, 301 is in both the compressed and uncompressed states. In defining the angle of the strut 324 relative to the X-direction, the X-direction can be regarded as being a line extending parallel to the X-direction indicated in the Cartesian coordinates shown in the drawings. When pivoting from the compressed state to the uncompressed state, the angle of the strut 324 relative to the X-direction decreases from the angle of the strut 324 relative to the X-direction when the strut 324 is in the compressed state. The uncompressed state is shown in FIG. 20 and the compressed state is shown in FIG. 22.

The extension portion 340 advantageously has a profile that is substantially identical to the internal profile of the cavity defined by the port 50 into which the dust cap 300, 301 is designed for connection to or insertion within, to prevent dust from passing between the extension portion 340 and the inner surface of the walls of such cavity, thereby preventing contamination of the ferrule end 16 that would otherwise occur even when the dust cap 300, 301 is installed. The extension portion 340 has, formed internal thereto and extending internally in the X-direction away from the insertion end 360 thereof, a ferrule cavity 350.

The shape or profile of the ferrule cavity 350 corresponds to (e.g., is a substantially identical negative of) the shape or profile of the ferrule end 16 of the connector 10 with which the dust cap 300, 301 is configured to engage to protect the ferrule end 16 of the connector 10 from dust infiltration and contamination. The shape or profile of the ferrule cavity 350 shown with respect to the dust caps 300, 301 disclosed herein is merely illustrative and is in no way limiting. Similarly, the depth of the ferrule cavity 350 shown is merely exemplary. It is preferable for the ferrule cavity 350 to have a depth that is the same as or greater than the depth of the ferrule end 16 of the connector 10, so that the entire ferrule end 16 of the connector 10 can be inserted within the ferrule cavity 350 of the dust caps 300, 301. Thus, the ferrule cavity 350 may have any shape and/or profile and/or depth, without limitation.

The base portion 310, the spring portion 320, and the extension portion 340 have, collectively, a length that is substantially the same as or, preferably, greater than the length (e.g., in the x-direction) of the cavity of the port 50 into which such dust cap 300, 301 is to be inserted. The distance by which the insertion end 360 of the dust cap 300, 301 extends beyond the midpoint of the cavity is less than the difference of the length of the spring portion 320 between the compressed and uncompressed states described herein. Thus, when two dust caps 300, 301 are installed in a cavity defined by a coaxially-aligned pair of ports 50, the dust caps 300, 301 being installed from opposite longitudinal ends of such cavity, the uncompressed length of the two dust caps 300, 301 is greater than the total length of the cavity within the housing 110 of the connector adapter 100. When the two dust caps 300, 301 are inserted within and secured within the coaxially-aligned ports 50 that define a cavity, the spring portion 320 of each of the dust caps 300, 301 is axially compressed (e.g., in the X-direction) such that the combined length of the base portion 310, the spring portion 320, and the extension portion 340 of both of the two dust caps 300, 301, when the spring portion 320 is in the compressed state, is substantially identical to the length of the cavity.

The base portion 310 and the extension portion 340 advantageously have alignment features 314, 316, 344, 346 formed on the upper and/or lower surfaces thereof to ensure proper alignment of the dust cap 300, 301 within the cavity of the connector adapter 100.

The base portion 310, the spring portion 320, and the extension portion 340 can be referred to herein together as constituting the main body of the dust cap 300, 301.

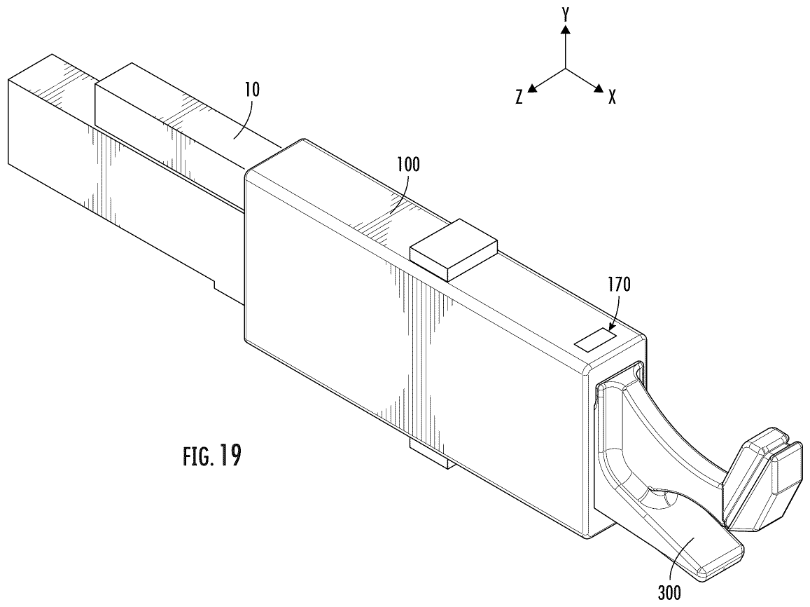

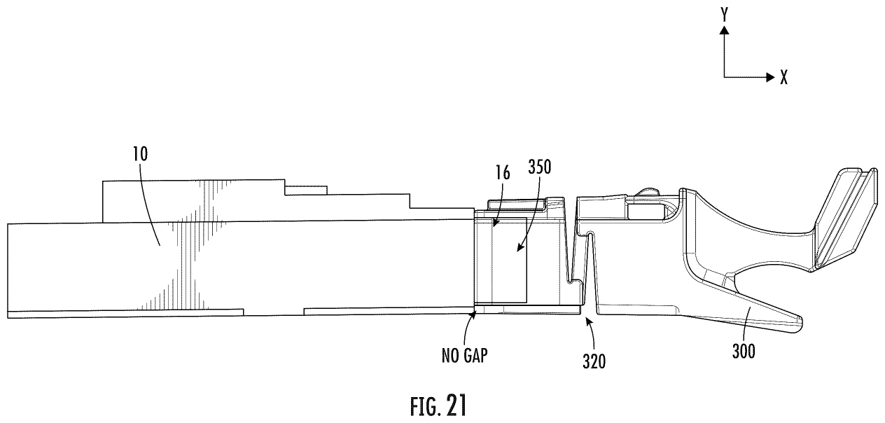

FIGS. 19-21 show an example assembly comprising a connector adapter 100 with two ports 50 that are coaxially-aligned with each other, a connector 10 being inserted within the first port 50 of the connector adapter 100 and a dust cap 300 being inserted within the second port 50 of the connector adapter 100. As shown in FIG. 20, while the ferrule end 16 of the connector 10 extends to a longitudinal midpoint (e.g., in the X-direction) of the cavity, the dust cap 300 extends, in the uncompressed state, beyond this longitudinal midpoint of the cavity in order for the ferrule end 16 of the connector 10 to be inserted or otherwise positioned within the ferrule cavity 350 of the dust cap 300, the ferrule cavity 350 essentially acting as a cover for the ferrule end 16 in this configuration. It is shown in FIG. 21 that the ferrule cavity 350 is substantially entirely inserted within the ferrule cavity 350, which has a depth (e.g., in the X-direction) that is the same as or greater than the depth (e.g., also in the X-direction) of the ferrule end 16, thereby preventing dust infiltration and contamination of the ferrule end 16 within the ferrule cavity 350. In the configuration shown in FIGS. 19-21, the spring portion 320 is in the uncompressed state.

FIG. 22 shows an example assembly comprising a connector adapter 100 with two ports 50 that are coaxially-aligned with each other, a dust cap 300 being inserted within both the first port 50 and the second port 50 that define the cavity. As shown in FIG. 22, the dust caps 300 contact each other at the respective insertion ends 360 thereof at the longitudinal midpoint of the cavity. However, since the dust cap 300, when the spring portion 320 is in the uncompressed state shown in FIG. 20, extends beyond the longitudinal midpoint of the cavity in the X-direction, the spring portion 320 of the respective dust caps 300 is compressed (e.g., by pivoting the strut 324 when moving into the compressed state) to shorten the length of each of the dust caps 300 substantially equally from the respective lengths thereof when the spring portion is in the uncompressed state. Thus, in FIG. 22, the spring portion of the respective dust caps 300 is shown in the compressed state.

FIG. 23 is a partially exploded assembly view of yet another assembly comprising the connector adapter installation housing 200 of FIGS. 7 and 8, a plurality of 2-port connector adapters (which are substantially identical to the connector adapters 100 shown in FIGS. 2-4, but having 2 ports 50 on each of the front and rear sides of the housing) installed within the connector adapter installation housing 200, ramp adapters 400 that are aligned with a row of the connector adapters 100 for removable installation thereon, and the example embodiment of the dust caps 300 shown in FIGS. 9-13, each of which is aligned with a different one of the ports 50 of the connector adapters 100 for removable installation therein. The dust caps 300 are inserted within one of the ports 50 of the connector adapter 100 after the installation of the ramp adapters 300 onto the connector adapters 100, to block the port 50 of the connector adapter 100 into which such dust cap 300 is inserted and also to cover the ramp portion of the ramp adapter 400, thereby preventing accumulation of dust on the ramp portion of said ramp adapter 400.

Utilizing a dust cap 300, 301 as disclosed herein, a corresponding method of installing a dust cap within a port of a connector adapter to prevent infiltration of dust within the connector adapter is provided. Such a method can include providing a dust cap 300, 301, aligning the dust cap 300, 301 with a designated one of the ports of a connector adapter, and inserting the dust cap 300, 301 into the designated port. The method comprises, when a connector is installed in a longitudinally opposing port, covering the ferrule end of such connector to prevent dust contamination on the ferrule end, the dust cap remaining in the uncompressed state. The method also comprises, when another dust cap is installed in the longitudinally opposing port, abutting the insertion (i.e. distal) ends of the dust caps 300, 301 against each other, the dust caps both being in the compressed state and having a combined length of the portions inserted into the connector adapter, when both dust caps 300, 301 are in the compressed state, that is substantially similar to the overall length of the cavity extending between the 2 ports in which the respective dust caps 300, 301 are installed. The method can further comprise actuating a latch of the dust cap 300, 301 to allow for removal of the dust cap 300, 301 from the connector adapter.

While the present disclosure refers to certain embodiments, numerous modifications, alterations, and changes to the described embodiments are possible without departing from the sphere and scope of the present disclosure, as defined in the appended claim(s). Accordingly, it is intended that the present disclosure not be limited to the described embodiments, but that it has the full scope defined by the language of the following claims, and equivalents thereof. The discussion of any embodiment is meant only to be explanatory and is not intended to suggest that the scope of the disclosure, including the claims, is limited to these embodiments. In other words, while illustrative embodiments of the disclosure have been described in detail herein, it is to be understood that the inventive concepts may be otherwise variously embodied and employed, and that the appended claims are intended to be construed to include such variations, except as limited by the prior art.

The foregoing discussion has been presented for purposes of illustration and description and is not intended to limit the disclosure to the form or forms disclosed herein. For example, various features of the disclosure are grouped together in one or more aspects, embodiments, or configurations for the purpose of streamlining the disclosure. However, it should be understood that various features of the certain aspects, embodiments, or configurations of the disclosure may be combined in alternate aspects, embodiments, or configurations. Moreover, the following claims are hereby incorporated into this Detailed Description by this reference, with each claim standing on its own as a separate embodiment of the present disclosure.

As used herein, an element or step recited in the singular and proceeded with the word “a” or “an” should be understood as not excluding plural elements or steps, unless such exclusion is explicitly recited. Furthermore, references to “one embodiment” of the present disclosure are not intended to be interpreted as excluding the existence of additional embodiments that also incorporate the recited features.

The phrases “at least one”, “one or more”, and “and/or”, as used herein, are open-ended expressions that are both conjunctive and disjunctive in operation. The terms “a” (or “an”), “one or more” and “at least one” can be used interchangeably herein. All directional references (e.g., proximal, distal, upper, lower, upward, downward, left, right, lateral, longitudinal, front, back, top, bottom, above, below, vertical, horizontal, radial, axial, clockwise, and counterclockwise) are only used for identification purposes to aid the reader's understanding of the present disclosure, and do not create limitations, particularly as to the position, orientation, or use of this disclosure. Connection references (e.g., engaged, attached, coupled, connected, and joined) are to be construed broadly and may include intermediate members between a collection of elements and relative to movement between elements unless otherwise indicated. As such, connection references do not necessarily infer that two elements are directly connected and in fixed relation to each other. All rotational references describe relative movement between the various elements. Identification references (e.g., primary, secondary, first, second, third, fourth, etc.) are not intended to connote importance or priority but are used to distinguish one feature from another. The drawings are for purposes of illustration only and the dimensions, positions, order and relative to sizes reflected in the drawings attached hereto may vary.

1. A dust cap comprising:
a main body configured for insertion within a port of a connector adapter, the main body comprising:
a spring portion configured to adjust a length of the main body of the connector adapter based on whether the dust cap is in a compressed state or an uncompressed state; and
a ferrule cavity at an insertion end of the main body, the ferrule cavity being configured to cover a ferrule end of a connector therein to block dust from contaminating the ferrule end while the ferrule cavity covers the ferrule end; and
a grip attached to a proximal end of the main body, the grip being configured to aid a user in inserting the dust cap into the port of the connector adapter or in removing the dust cap from the connector adapter;
wherein the proximal end is an opposite end of the main body from the insertion end.

2. The dust cap of claim 1, wherein the spring portion is deformable between the uncompressed state and the compressed state, the length of the main body being greater when the dust cap is in the uncompressed state than when the dust cap is in the compressed state.

3. The dust cap of claim 1, wherein the main body comprises a base portion and an extension portion, the spring portion being located between and connecting together the base portion and the extension portion.

4. The dust cap of claim 3, wherein the spring portion comprises at least one strut that has a first end, where the at least one strut is pivotably attached to the base portion at a first hinge point, and a second end, where the at least one strut is pivotably attached to the extension portion at a second hinge point, the first and second ends being opposite ends of the at least one strut.

5. The dust cap of claim 4, wherein the spring portion is configured such that, in moving from the uncompressed state to the compressed state, the strut pivots about the first hinge point in a first rotary direction and about the second hinge point in a second rotary direction.

6. The dust cap of claim 5, wherein the first rotary direction is opposite from the second rotary direction.

7. The dust cap of claim 6, wherein, as the dust cap moves from the uncompressed state to the compressed state, an angle of the strut increases relative to a longitudinal axis of the main body.

8. The dust cap of claim 7, wherein, in the uncompressed state, the angle of the strut is less than 90° and, in the compressed state, the angle of the strut is greater than 90°.

9. The dust cap of claim 8, wherein the spring portion is configured to deform only in elastic deformation when moving between the compressed and uncompressed states.

10. The dust cap of claim 3, wherein the spring portion is directly attached to the base portion and is also directly attached to the extension portion.

11. The dust cap of claim 3, wherein the grip, the base portion, the spring portion, and the extension portion have a unitary or monolithic construction.

12. The dust cap of claim 1, comprising a ramp cover configured to cover a ramp portion of a ramp adapter attached to the connector adapter into which the dust cap is configured for insertion, the ramp cover being configured to prevent accumulation of dust on the ramp portion while the dust cap is inserted into the port of the connector adapter.

13. The dust cap of claim 1, wherein the ferrule cavity has a shape and depth configured for the ferrule end of the connector to be inserted at least partially within the ferrule cavity to protect the ferrule end from dust contamination.

14. The dust cap of claim 1, wherein the ferrule cavity has a shape and depth configured for the ferrule end of the connector to be inserted fully within the ferrule cavity to protect the ferrule end from dust contamination.

15. The dust cap of claim 1, wherein the ferrule cavity has a substantially similar shape or profile as the ferrule end of the connector.

16. The dust cap of claim 1, wherein the ferrule cavity has a depth that is at least substantially similar to or greater than a depth of the ferrule end of the connector.

17. The dust cap of claim 1, comprising a latch configured to secure the dust cap.

18. The dust cap of claim 17, wherein the latch is formed vertically above a base portion of the main body.

19. A method for connecting a dust cap to a connector adapter using the dust cap of claim 1.
